(19) United States
(12) Patent Application Publication
(10) Pub. No.: US 2002/0095562 A1
(43) Pub. Date: Jul. 18, 2002

(54) Arithmetic unit comprising a memory shared by a plurality of processors

(75) Inventors: Chikako Nakanishi, Hyogo (JP); Hisakazu Sato, Hyogo (JP)

Correspondence Address: McDERMOTT, WILL & EMERY, 600 13th Street, N.W., Washington, DC, 20005-3096, US

(73) Assignee: MITSUBISHI DENKI KABUSHIKI KAISHA

(21) Appl. No.: 09/972,157

(22) Filed: Oct. 9, 2001

(30) Foreign Application Priority Data
Jan. 12, 2001 (JP) 2001-004622(P)

(51) Int. Cl. G06F 15/00

(52) U.S. Cl. 712/34

(57) ABSTRACT

A shared memory shared between a parent processor and a coprocessor core includes two buffers. An access control part allows one of the two buffers to exclusively access one of either the parent processor or the coprocessor core in accordance with the buffer designation data. The buffer designation data are stored in a control register allocated to a specific address and are rewritten by the parent processor in a software manner.

### BACKGROUND OF THE INVENTION

1. Field of the Invention

The present invention relates to an arithmetic unit, in particular, to an arithmetic unit comprising a memory shared by a plurality of processors, which carry out processing independent of each other.

2. Description of the Background Art

In recent years in order to increase the processing performance of the entire system, technologies where an MCU (micro processor unit, hereinafter referred simply as parent processor) and a DSP (digital signal processor) are integrated into one chip or where a system is configured so that a high performance programmable coprocessor is added to an MCU have come into increasing use.

In these systems, an MCU, which is a parent processor, controls a DSP or a high performance programmable coprocessor so as to perform the processing while maintaining synchronization. These processors carry out, independent of each other, instruction sequences and need to synchronize with each other only if necessary and, therefore, parallel processing can be implemented comparatively easily so as to greatly contribute to an increase in the processing performance of the entire system. In the following, the DSP and the programmable coprocessor are generically referred to, simply, as coprocessors.

At present, in an arithmetic unit comprising a system wherein a parent processor and a coprocessor independently carry out different instruction sequences in the above manner, interface systems between the parent processor and the coprocessor are divided into the following two types.

FIGS. 12 and 13 are the first and second schematic block diagrams showing a configuration of a conventional arithmetic unit which has a parent processor and a coprocessor.

Referring to FIG. 12, a conventional arithmetic unit 100, includes a parent processor (MCU) 101 and a coprocessor 102 which, respectively, carry out arithmetic processing independently, a shared memory 103, which is shared by the parent processor 101 and the coprocessor 102, and a bus BS, which allows data transmission and reception between these units. The parent processor 101 and the coprocessor 102, respectively, allow the data input/output carried out to and from the shared memory 103 through the bus BS.

In such as configuration, the arithmetic unit 100 allows data to be shared between the parent processor 101 and the coprocessor 102 via the shared memory 103.

Referring to FIG. 13, a conventional arithmetic unit 110 includes a parent processor (MCU) 101 and a coprocessor 102, which, respectively, carry out arithmetic processing independently, an input buffer 105, which temporarily stores the data outputted from the parent processor 101 so as to transmit the data to the coprocessor 102, and an output buffer 106, which temporarily stores the data outputted from the coprocessor 102 so as to transmit the data to the parent processor 101.

A buffer of, for example, an FIFO (First In First Out) system is used for the input buffer 105 and the output buffer 106. In this manner, by providing a specific hardware for transferring data between the parent processor 101 and the coprocessor 102, data can be shared between the parent processor 101 and the coprocessor 102.

In the arithmetic units described in FIGS. 12 and 13, however, in some case the following problems may arise.

Firstly, a risk of the occurrence of data destruction is cited. The data destruction occurs when the coprocessor rewrites the data utilized by the parent processor or when, on the contrary, the parent processor rewrites the data utilized by the coprocessor. On the other hand, since the parent processor and the coprocessor carry out arithmetic processing independent of each other, a memory management which takes the timing into consideration is difficult. Accordingly, a problem arises since meticulous attention must be paid in the preparation of the program in order to avoid data destruction.

Secondly, an occurrence of an access conflict is cited. The access conflict occurs when the parent processor and the coprocessor simultaneously carry out the data read out request or the data write in request to and from the shared memory, that is to say, when they simultaneously carry out the access requests. A problem arises since measures are necessary, in order to avoid the access conflict, to convert the memory to a two port memory, or the like, which leads to an increase in circuit scale.

In order to avoid the occurrences of such data destruction and access conflict, a system can be adopted where memories are independently allocated to individual processors.

In the case that such as system is adopted, however, it becomes necessary to forward data from the parent processor to the coprocessor or from the coprocessor to the parent processor in order to share the data. In order for the data transferring to take place it becomes necessary to repeatedly carry out the data read out processing from the memory and the data write in processing to a different memory and, therefore, the processors are occupied by this data read out processing and this data write in processing. As a result of this, a new problem arises that the overhead becomes large for the data sharing.

The overhead due to the data transferring leads to deterioration of the processing performance of the entire system, that is to say, deterioration of the performance of the arithmetic unit, which becomes a large problem. Accordingly, it becomes important to avoid problems due to a shared memory system, such as data destruction or access conflict in an arithmetic unit which adopts a shared memory system wherein no overhead occurs due to data sharing.

### SUMMARY OF THE INVENTION

It is an object of the present invention to provide an arithmetic unit of a shared memory system which can avoid data destruction and access conflict.

The present invention is, in summary, an arithmetic unit which includes a first arithmetic processing part and a memory part. The first arithmetic processing part carries out arithmetic processing. The memory part is shared by the first arithmetic processing part and a second arithmetic processing part that can carry out arithmetic processing independently of the first arithmetic processing part. The memory part includes first and second buffer parts, that can, respectively, write in and read out data independently of each other, and an access control part, for determining pairs of each of the first and second buffer parts and one of the first or second arithmetic processing parts based on a buffer designation that can be changed by the second arithmetic processing part, and for exclusively carrying out access in each of the pairs.

Accordingly, the main advantage of the present invention is that the memory part which is divided into two buffer parts, each of which is formed of one port memory, can be shared by the first arithmetic processing part, corresponding to a coprocessor, and the second arithmetic processing part, corresponding to an MCU. As a result of this, data sharing which avoids the overhead as well as the avoidance of data destruction and access conflict can be achieved.

According to another aspect of the present invention, an arithmetic unit includes a first arithmetic processing part and a memory part. The first arithmetic processing part carries out arithmetic processing. The memory part is shared by the first arithmetic processing part and a second arithmetic processing part, which can carry out arithmetic processing independently of the first arithmetic processing part. The memory part includes first and second buffer parts, that allow data write in and data read out independent of each other and, each of, which has two input/output ports, and an access control part, for transmitting the read out data from one of the first and the second buffer parts, which are designated in accordance with the first read buffer designation that can be changed by the second arithmetic processing part, to the first arithmetic processing part in the case that a data read out request is received from at least one of the first and the second arithmetic processing parts and for transmitting the read out data from one of the first and the second buffer parts, which are designated in accordance with the second read buffer designation that can be changed by the second arithmetic processing part, to the second arithmetic processing part. The access control part transmits the write in data, from either the first or the second arithmetic processing part to either the first or the second buffer parts, which are determined based on the write buffer designation which can be changed by the second arithmetic processing part in the case that a data write in request is received from either one of the first and the second arithmetic processing part.

Accordingly, the memory part formed of a two port memory can be shared by the first arithmetic processing part, corresponding to a coprocessor, and the second arithmetic processing part, corresponding to an MCU and, at the same time, the buffer commonly used by the first and second arithmetic processing parts can be designated as the objective of the data read out. As a result of this, data sharing which avoids the overhead is achieved and, at the same time, the avoidance of data destruction and access conflict can be achieved in addition to an increase in the degree of freedom of buffer designation.

According to still another aspect of the present invention, an arithmetic unit includes a first arithmetic processing part and a memory part. The first arithmetic processing part carries out arithmetic processing. The memory part is shared by the first arithmetic processing part and a second arithmetic processing part, which can carry out arithmetic processing independently of the first arithmetic processing part. The memory part includes a plurality of buffer parts, which allow implementation of data write in and data read out independently of each other and an access control part, for carrying out access between one of the plurality of buffers, which is determined based on the first buffer designation that can be changed by the second arithmetic processing part, and the first arithmetic processing part, as well as between one of the plurality of buffers, which is determined based on the second buffer designation that can be changed by the second arithmetic processing part, and the second arithmetic processing part.

Accordingly, the memory part, which is divided into a plurality of buffer parts, each of which is formed of a one port memory, is shared by the first arithmetic processing part, corresponding to a coprocessor, and the second arithmetic processing part, corresponding to an MCU. As a result of this, in addition to the implementation of memory sharing, which enhances versatility, data sharing which avoids the overhead can be achieved together with the avoidance of data destruction and access conflict.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram showing the configuration of an arithmetic unit according to a first embodiment of the present invention;

FIG. 2 is a circuit diagram showing the configuration of a shared memory shown in FIG. 1;

FIG. 3 is a diagram for describing the configuration of data set in a control register shown in FIG. 1;

FIG. 4 is a conceptual diagram showing an example of address mapping in the arithmetic unit;

FIG. 5 is a diagram showing the configuration of data set in a control register according to a second embodiment;

FIG. 6 is a block diagram showing the configuration of a shared memory according to the second embodiment;

FIG. 7 is a diagram for describing the configuration of data set in a control register according to a third embodiment;

FIG. 8 is a block diagram showing the configuration of a shared memory according to the third embodiment of the present invention;

FIG. 9 is a schematic block diagram showing the configuration of an arithmetic unit according to a fourth embodiment of the present invention;

FIGS. 10A and 10B are diagrams showing the configuration of data set in a control register according to the fourth embodiment;

FIG. 11 is a block diagram showing the configuration of a shared memory according to the fourth embodiment;

FIG. 12 is a first schematic block diagram showing a configuration of a conventional arithmetic unit which has a parent processor and a coprocessor; and

FIG. 13 is a second schematic block diagram showing a configuration of a conventional arithmetic unit which has a parent processor and a coprocessor.

### DESCRIPTION OF THE PREFERRED EMBODIMENTS

In the following, the embodiments of the present invention are described in detail referring to the drawings. Here, the same, or the corresponding, parts are referred to by the same signs in the figures.

First Embodiment

Referring to FIG. 1, an arithmetic unit 1 according to the first embodiment of the present invention includes a coprocessor 3 and parent processor (MCU) 4, which, respectively, carry out arithmetic processing independently. The coprocessor 3 includes a coprocessor core 6, for carrying out arithmetic processing, a coefficient memory 7 and an instruction memory 8, for storing data necessary for arithmetic processing in the coprocessor core 6, a control register 9, for storing specific data referred to by the coprocessor core 6, and a shared memory 10, shared with the parent processor 4.

Here, in the arithmetic unit 1 it is possible to form the parent processor (MCU) 4 and the coprocessor 3 in the same semiconductor chip and to form them in different semiconductor chips, respectively.

The arithmetic unit 1 further includes a bus BS, for carrying out data transmission and reception between the parent processor 4 and the coprocessor 3. The bus BS is arranged between the control register 9 as well as the shared memory 10 on the one hand and the parent processor 4 on the other. The parent processor 4 can access the shared memory 10 and the control register 9 via the bus BS.

The coprocessor core 6 is connected to the coefficient memory 7, the instruction memory 8, the control register 9 and the shared memory 10 by means of the an internal bus. Accordingly, the coprocessor core 6 can access the shared memory 10. In this manner, both the parent processor 4 and the coprocessor core 6 can access, that is to say can carry out data read out and data write in to and from, the shared memory 10.

The control register 9 is allocated to a specific address in the parent processor 4 and the parent processor 4 writes in a value to this specific address for the software setting.

Writing in to the control register 9 is possible only by the parent processor 4 and reading out from the control register 9 is possible by both the parent processor 4 and the coprocessor core 6. That is to say, only read out from the control register 9 is possible by the coprocessor core 6.

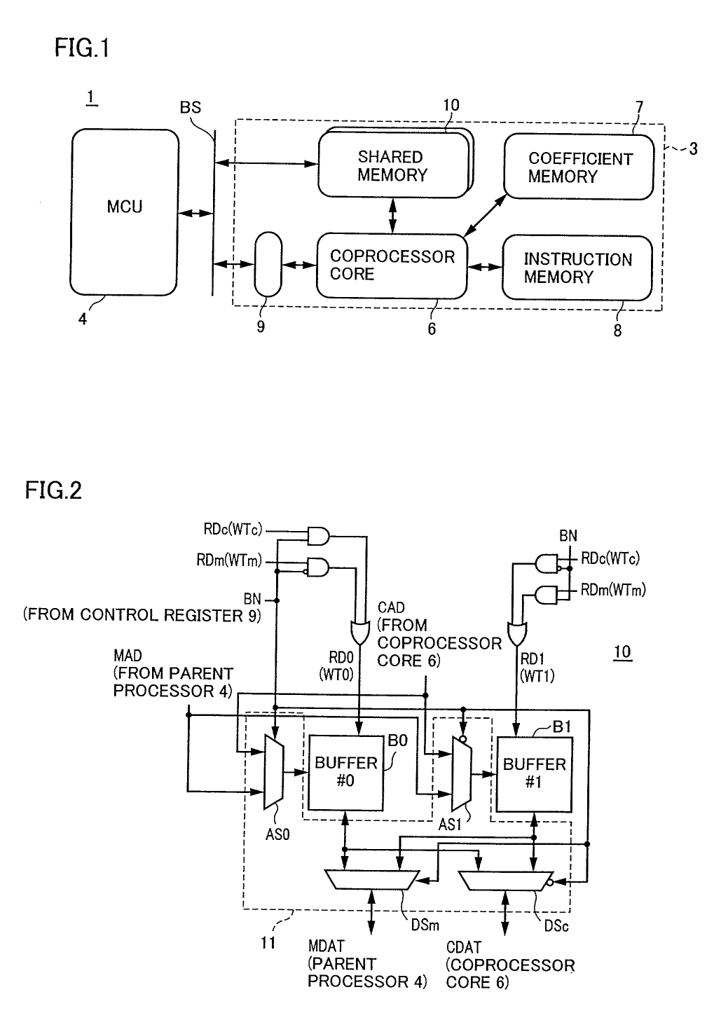

Referring to FIG. 2, the shared memory 10 is divided into two regions which include a buffer B0 and a buffer B1, which allow the implementation of data input/output independent of each other. Though not shown, each of the buffers B0 and B1 is connected to the parent processor 4 and the coprocessor core 6, respectively, by means of a dedicated bus. Accordingly, control signals RDm and WTm for requesting data read out and data write in, respectively, from the parent processor 4 and control signals RDc and WTc for requesting data read out and data write in, respectively, from the coprocessor core 6 can be transmitted to each of the buffers B0 and B1. These control signals are set at “1” in the case that data read out/write in is requested.

Based on the data set in the control register 9, each of the two buffers, B0 and B1, is combined with one of the parent processor 4 and the coprocessor core 6, respectively.

The shared memory 10 further includes an access control part 11 for implementing exclusive access in each of the above combinations. By providing the access control part 11, the buffer B0 and the buffer B1 need not be two port memories but, rather, can be formed of single port memories.

The access control part 11 has address selection circuits AS0 and AS1 for selectively transmitting addresses which are provided to correspond to, respectively, the buffers B0 and B1 and data selection circuits DSm and DSc, for selecting either the buffer B0 of the buffer B1 as the objective of the access, that is to say, the data input/output, which are provided to correspond to, respectively, the parent processor 4 and the coprocessor core 6.

The address selection circuit AS0 transmits either the address MAD, wherein access is requested from the parent processor 4 (hereinafter also referred to as, simply, parent processor address MAD), or the address CAD, wherein access is requested from the coprocessor core 6 (hereinafter also referred to as, simply, coprocessor address CAD), to the buffer B0 in accordance with the buffer designation data BN set in the control register 9. The address selection circuit AS1 carries out a selection which is complementary to the selection by the address selection circuit AS0 so as to transmit either the parent processor address MAD or the coprocessor address CAD, whichever was not transmitted in the above, to the buffer B1.

The data selection circuit DSm transmits and receives the parent processor core data MDAT, which are inputted/outputted to and from the parent processor 4, to and from either the buffer B0 or the buffer B1, in accordance with the buffer designation data BN. The data selection circuit DSc carries out a buffer selection which is complementary to the selection by the data selection circuit DSm so as to transmit and receive the coprocessor core data CDAT, which are inputted/outputted to and from the coprocessor core 6, to and from either the buffer B0 or the buffer B1, whichever was not selected in the above, in accordance with buffer designation data BN.

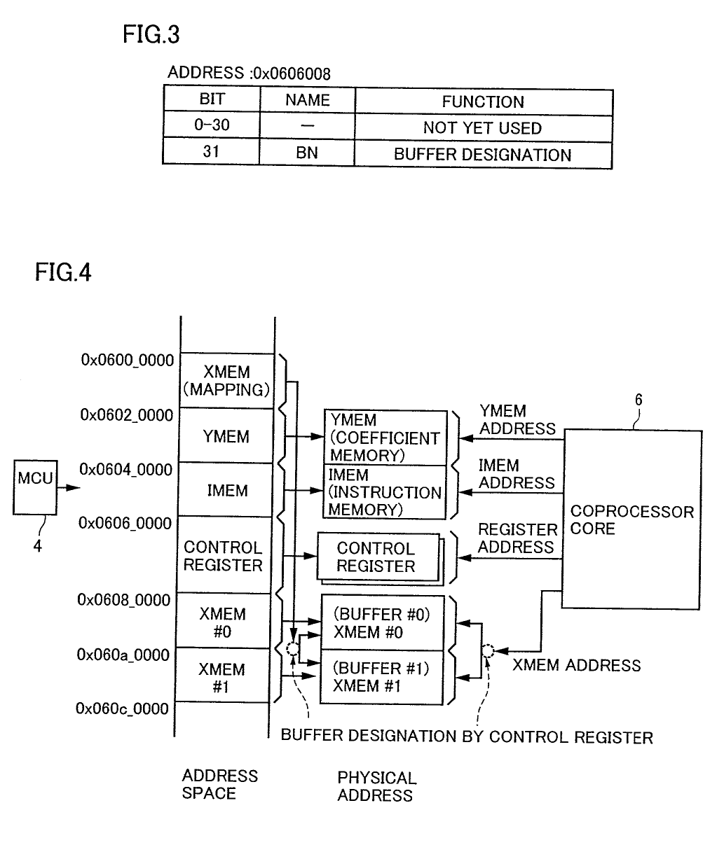

Referring to FIG. 3, the control register 9 is allocated to a specific address (address 0x0606008 in FIG. 3) of the parent processor 4 and at the lowest bit thereof the buffer designation data BN is set.

In the case that the value of the buffer designation data BN is “0,” it becomes possible for the parent processor 4 to access the buffer B0 and for the coprocessor core 6 to access the buffer B1. On the contrary, in the case that the value of the buffer designation data BN is “1,” the condition is gained where it becomes possible for the parent processor to access the buffer B1 and for the coprocessor core to access the buffer B0.

Next, an exclusive access selection of the buffers at the time of data read out and data write in is described.

Again referring to FIG. 2, in the case that the control signal RDm is set at “1” when data read out is requested from the parent processor 4 and the value of the buffer designation data BN is “0” or in the case that the control signal RDc is set at “1” when data read out is requested from the coprocessor core 6 and the value of the buffer designation data BN is “1,” the read out control signal RD0 for the buffer B0 is activated to “1.” In response to this, in the buffer B0, data read out is carried out based on the address selected by the address selection circuit AS0. The read out data from the buffer B0 are transmitted to either the parent processor 4 or the coprocessor core 6, whichever has requested the data read out, by the corresponding data selection circuit DSm or DSc, as the parent processor core data MDAT or the coprocessor core data CDAT.

On the other hand, in the case that the control signal RDm is set at “1” when data read out is requested from the parent processor 4 and the value of the buffer designation data BN is “1,” or in the case that the control signal RDc is set at “1” when data read out is requested from the coprocessor core 6 and the value of the buffer designation data BN is “0,” the read out control signal RD 1 for the buffer B1 is activated to “1.” In response to this, in the buffer B1, data read out is carried out based on the address selected by the address selection circuit AS1. In the same manner, the read out data from the buffer B1 are transmitted to either the parent processor 4 or the coprocessor core 6, whichever has requested the data read out, by the corresponding data selection circuit DSm or DSc as the parent processor core data MDAT or the coprocessor core data CDAT.

As shown in FIG. 2, the write in control signals WT0 and WT1, which respectively correspond to the buffers B0 and B1, are generated in the same manner as the read out control signals RD0 and RD1. Data write in to the buffers B0 and B1 is carried out in accordance with the addresses selected by the address selection circuits AS0 and AS1, respectively, in response to the activation (“1” setting) of the write in control signals WT0 and WT1, respectively.

The parent processor core data MDAT or the coprocessor core data CDAT which are inputted from either the parent processor 4 or from the coprocessor core 6, whichever has requested data write in, are transmitted to either the buffer B0 or B1, whichever becomes the objective of data write in by the corresponding data selection circuit DSm or DSc.

Referring to FIG. 4, the address space XMEM (mapping) corresponds to the shared memory 10 in FIG. 1. The address spaces YMEM and IMEM, respectively, correspond to the coefficient memory 7 and the instruction memory 8. In addition, the address spaces XMEM#0 and XMEM#1 directly correspond to the buffers B0 and B1, respectively. Here, these address spaces shown in FIG. 4 do not indicate the address mapping of the entire arithmetic unit 1 but, rather, show the address mapping seen from the parent processor (MCU) 4.

As shown in FIG. 4, the address region 0x0600_{—}0000˜0x601_fff which corresponds to the address space XMEM is allocated to both the buffers B0 and B1, which form the shared memory 10. Thereby, the contents of both buffers B0 and B1 can be referred to (data read out) or can be updated (data write in) by using the same address from the parent processor 4. At this time, which of the buffers, B0 or B1, that is to be accessed is determined by the already described value of the buffer designation data BN set in the control register 9.

In addition to the above described address spaces, the address space 0x0608_{—}0000˜0x0609_fff and the address space 0x060a_{—}0000˜0x060b_fff are, respectively, allocated to the buffers B0 and B1. These addresses are the addresses which allow access only during the time when the coprocessor 3 is stopped. As a result of this, the buffers B0 and B1 can be accessed from the parent processor 4 even during the time when the coprocessor 3 is stopped.

The control register is allocated to the address from 0x060a_{—}0000 and the parent processor 4 can set the buffer designation data BN in the control register 9 by writing a value into this address. By properly rewriting the buffer designation data BN so as to switch the access objective buffers of the parent processor 4 and the coprocessor core 6, data can be shared between the parent processor 4 and the coprocessor core 6.

In accordance with such a configuration of an arithmetic unit according to the first embodiment, in addition to making data sharing possible by means of the shared memory configuration, data destruction and access conflict can be avoided. In addition, it is not necessary to covert memory which forms each buffer to a two port memory so that the shared memory can be formed of a one port memory. Furthermore, the advantage of the shared memory configuration wherein no overhead occurs due to data forwarding for data sharing is maintained as it is.

Second Embodiment

In the second embodiment a configuration wherein the function of the control register is added is shown.

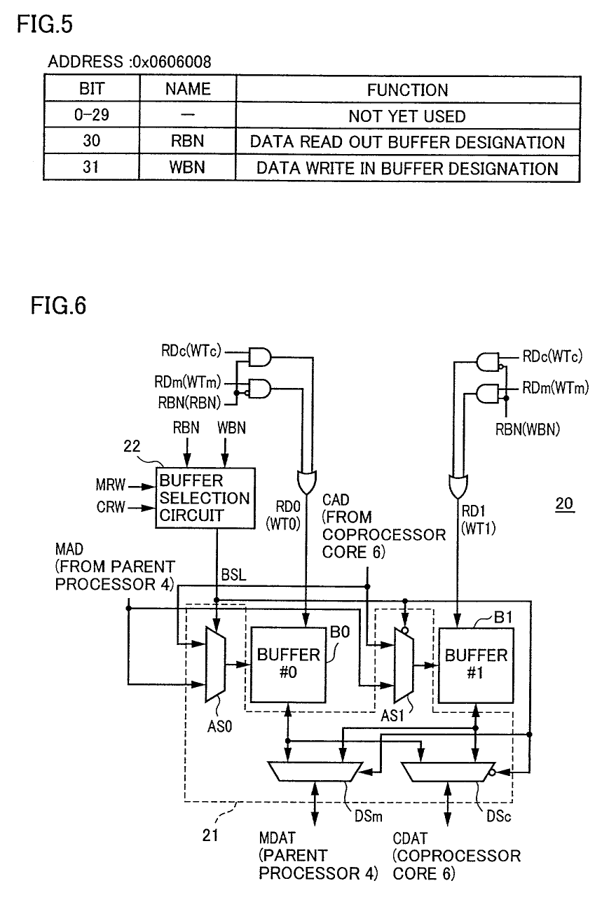

Referring to FIG. 5, buffer designation at the time of data read out and at the time of data write in can be independently carried out by using the lowest two bits of the control register in the second embodiment. More concretely, by using these two bits the read buffer designation data RBN and the write buffer designation data WBN are set.

For example, in the case that the value of the read buffer designation data RBN is set “0,” it becomes possible for the parent processor 4 to access the buffer B0 and for the coprocessor core 6 to access the buffer B1 at the time of data read out. In the same manner, in the case that the value of the write buffer designation data WBN is set at “0,” it becomes possible for the parent processor 4 to access the buffer B1 and for the coprocessor core 6 to access the buffer B0 at the time of data write in.

In the same manner as in the case of the first embodiment, the write in to the control register 9 is possible only from the parent processor 4 while the read out from the control register 9 is possible to both the parent processor 4 and the coprocessor core 6.

Referring to FIG. 6, the shared memory 20 according to the second embodiment is different, in comparison with the shared memory 10 according to the first embodiment shown in FIG. 2, in the point that it further includes a buffer selection circuit 22 which generates a buffer selection signal BSL.

In addition, the address selection circuits AS0, AS1 and the data selection circuits DSm, DSc included in the access control part 21 are different, from the configuration in the first embodiment, in the point that the selection is carried out in accordance with the buffer selection signal BSL generated by the buffer selection circuit 22.

In the shared memory 20 the combination of the buffer and the processor which carry out exclusive access, respectively, is determined independently at the time of data read out and at the time of data write in.

The buffer selection circuit 22 generates the buffer selection signal BSL in accordance with the read buffer designation data RBN and the write buffer designation data WBN, which are set in the control register 9, as well as the parent processor read out/write in signal MRW and the coprocessor read out/write in signal CRW.

The parent processor read out/write in signal MRW is set at “0” in the case that data read out is requested by the parent processor 4 and is set at “1” in the case that data write in is requested. In the same manner, the coprocessor core read out/write in signal CRW is set at “0” or “1” in the case that data read out or data write in, respectively, is requested by the coprocessor.

Here, the data read out request from the parent processor and the data write in request from the coprocessor do not occur simultaneously while the data write in indication from the processor and the data read out from the coprocessor do not occur simultaneously.

The buffer selection circuit 22 generates the buffer selection signal BSL in accordance with these inputted control signals by carrying out a logic operation based on the following equation (1):

BSL=(/MRW·RBN)+(MRW·WBN)+(CRW·WBN)+(/CRW·RBN) (1).

Here, the symbols “/,” “·” and “+” in equation (1) represent, respectively, logic operations of NOT, AND and OR.

In addition, for the generation of the read out control signals RD0, RD1 and the write in control signals WT0, WT1, as shown in FIG. 6, in contrast to the case of the first embodiment, the read buffer designation data RBN or the write buffer designation data WBN may be used in place of the buffer designation data BN.

In the arithmetic unit according to the second embodiment, the elements, other than the configuration of the shared memory and the data set in the control register, are the same as in the first embodiment, of which the detailed descriptions are not repeated.

In such a configuration it becomes possible to independently designate buffers which become the access objective for data write in and data read out, respectively, and, therefore, the degree of freedom of buffer designation can be increased in addition to the effects exercised by the arithmetic unit according to the first embodiment, which has a shared memory configuration.

Third Embodiment

In the third embodiment, a configuration is described wherein the degree of freedom of buffer designation at the time of data read out is further increased.

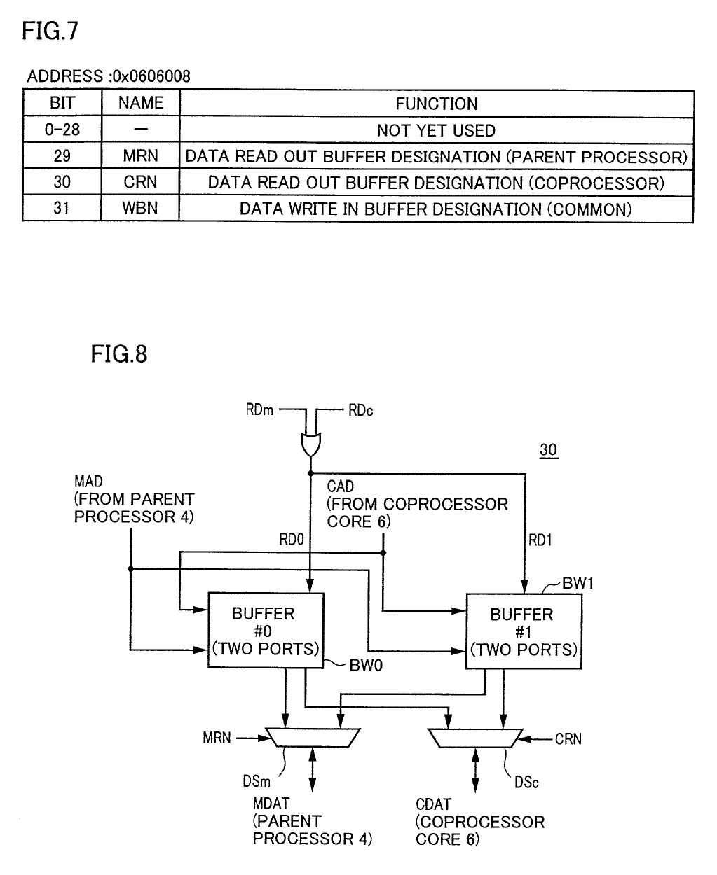

Referring to FIG. 7, in the third embodiment, by using the lowest three bits of the control register, the read buffer designation data MRN for designating the data read out objective buffer of the parent processor 4, the read buffer designation data CRN for designating the data read out objective buffer of the coprocessor core 6 and the write buffer designation data WBN for showing the allocation of the objective buffer at the time of data write in are set.

The values of the read buffer designation data MRN and CRN can be independently set by the parent processor 4 and the coprocessor core 6 by using different bits. Accordingly, data read out having a common buffer as the objective becomes possible by means of the parent processor 4 and coprocessor core 6.

On the other hand, the buffer which becomes the objective of data write in is exclusively designated by write buffer designation data WBN in the same manner as in the case of the second embodiment in order to avoid data destruction.

Here, in the same manner as in the first and second embodiments, write in to the control register 9 is possible only from the parent processor 4 while read out from the control register 9 is possible to both the parent processor 4 and the coprocessor core 6.

In FIG. 8, the configuration with respect to data read out from the shared memory 30 according to the third embodiment is shown.

Referring to FIG. 8, the buffers BW0 and BW1 formed of two port memories are arranged in the shared memory 30 in order to implement data read out from both the parent processor 4 and the coprocessor core 6, which have the same buffer as the objective. Thereby, it is made possible for two addresses to be read out in each of the buffers BW0 and BW1.

Accordingly, data read out is requested to each of the buffers BW0 and BW1 from either the parent processor 4 or the coprocessor core 6 and, in the case that the control signal RDm or RDc is set at “1,” each of the read out control signals RD0 and RD1 may be set at “1.”

The data selection circuit DSm receives read out data from each of the buffers BW0 and BW1 and transmits the data in accordance with the read buffer designation data MRN to the parent processor 4 as the parent processor core data MDAT.

In the same manner, the data selection circuit DSm receives read out data from each of the buffers BW0 and BW1 and transmits the data in accordance with the read buffer designation data CRN to the coprocessor core 6 as the coprocessor core data CDAT.

Here, though the data write in in the shared memory 30 is omitted in the figure, the write in control signals WT0, WT1 for the buffers B0, B1 are generated in the same manner as in the second embodiment and the buffer selection in the data selection circuits DSm and DSc are carried out in accordance with the write buffer designation data WBN and the inverted signal thereof, respectively, in the configuration.

In the arithmetic unit according to the third embodiment, the configuration of the parts, other than the shared memory and the control register, is the same as in the first embodiment, of which the detailed descriptions are not repeated.

In such a configuration, the degree of freedom of buffer designation is further increased above that of the arithmetic unit according to the second embodiment, which has a shared memory configuration, and the processing performance of the arithmetic unit can be improved by making possible data read out from the same buffer.

Here, the control register 9 may be formed so that write in of the buffer designation data is possible not only from the parent processor 4 but also from the coprocessor core 6 in each of the first to third embodiments. Here, in this case, in order to avoid data destruction and access conflict it is necessary to carry out write in control for the control register 9.

Fourth Embodiment

In the fourth embodiment the configuration is described wherein the configuration according to the first embodiment, which has a shared memory divided into two buffers, can be expanded to a shared memory divided into a plurality of three, or more, buffers.

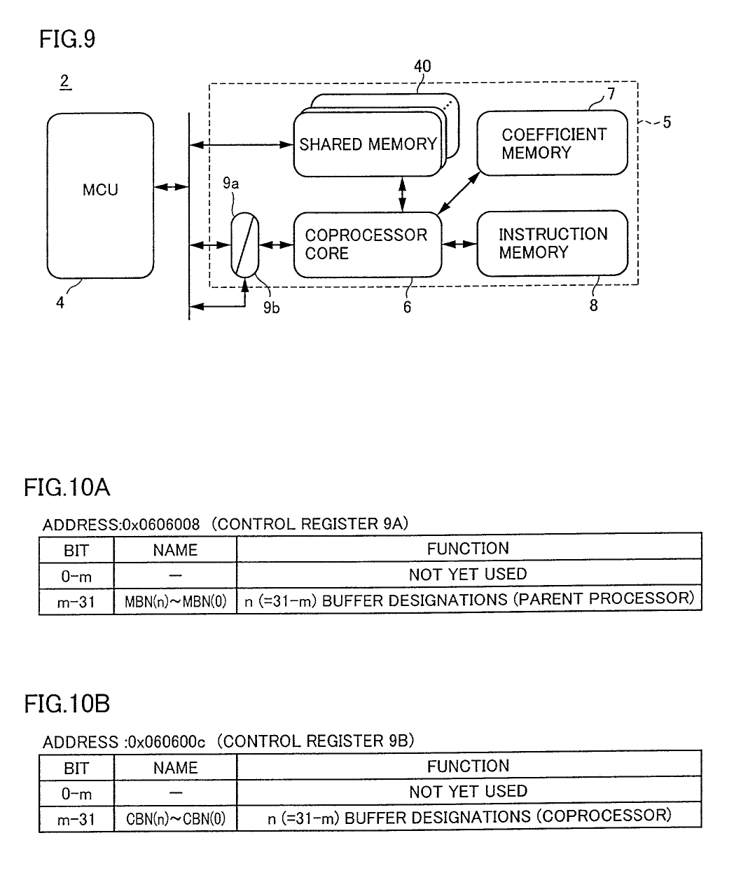

Referring to FIG. 9, an arithmetic unit 2 according to the fourth embodiment of the present invention is different, in comparison with the arithmetic unit 1 shown in FIG. 1, in the point that a shared memory 40, which is divided into (n+1) buffer regions (n: integer) in place of the shared memory 10, which is divided into two buffer regions.

In addition, the control register 9 is divided into a control register 9a for designating a buffer utilized by the parent processor 4 and a control register 9b for designating a buffer utilized by the coprocessor core 6. The configuration of the other parts is the same as in the arithmetic unit 1 shown in FIG. 1, of which the detailed descriptions are not repeated. In the arithmetic unit 2, also, it is possible to form the parent processor (MCU) 4 and the coprocessor 3 in the same semiconductor chip or to form them in different semiconductor chips, respectively.

In FIGS. 10A and 10B, the data configuration set in the control register according to the fourth embodiment is shown.

Referring to FIG. 10A, by using the lowest (n+1) bits of the control register 9a, the buffer designation data MBN(0)˜MBN(n), for designating an access objective buffer from the parent processor 4, are set. In the buffer Bi (i: an integer of 0 to n) designated by the parent processor as the access objective, the value of the corresponding buffer designation data MBN(i) is set at “1.”

Referring to FIG. 10B, by using the lowest (n+1) bits of the control register 9b, the buffer designation data CBN(0)˜CBN(n), for designating the access objective buffer from the coprocessor core 6, are set. In the buffer Bi (i: an integer of 0 to n) designated by the coprocessor as the access objective, the value of the corresponding buffer designation data CBN(i) is set at “1.”

In the same manner as in the cases of the first to third embodiments, write in to the control register 9a and 9b is possible only from the parent processor 4 and data read out from the control register 9a and 9b into both the parent processor 4 and the coprocessor core 6 is possible. Here, in the following, the buffer designation data MBN(0)˜MBN(n) and CBN(0)˜CBN(n) are, respectively, generically referred to as merely the buffer designation data MBN and CBN.

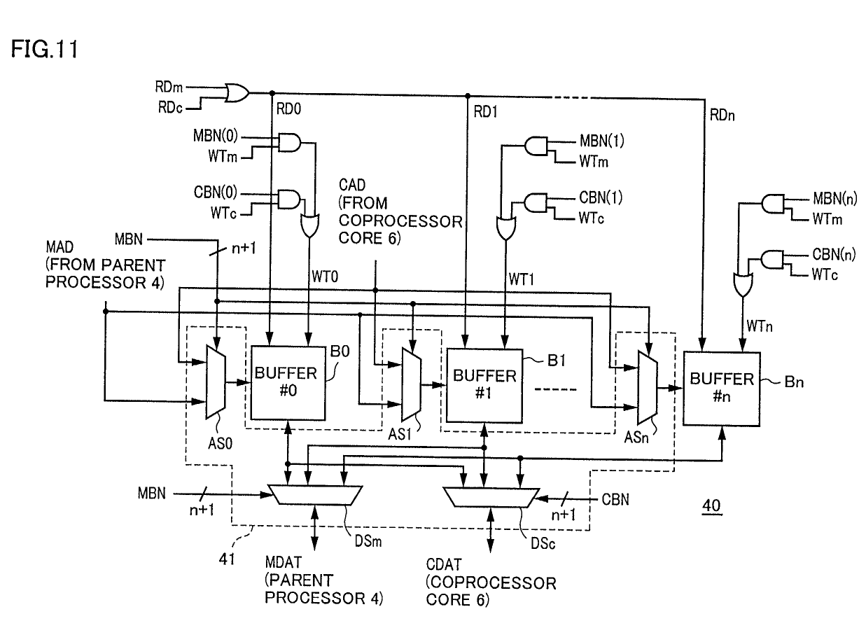

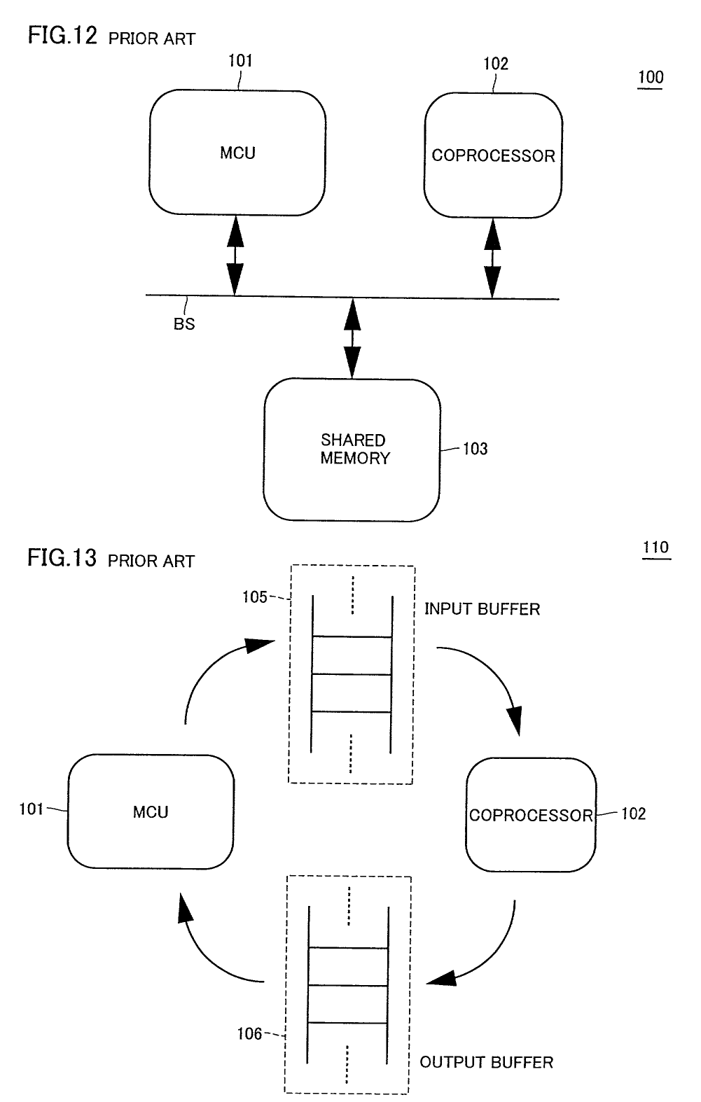

Referring to FIG. 11, the shared memory 40 according to the fourth embodiment is divided into (n+1) regions and includes the buffers B0 to Bn, which allow data input/output independent of each other, and an access control part 41.

The access control part 41 has the address selection circuits AS0 to ASn provided, respectively, corresponding to the buffers B0 to Bn, a data selection circuit DSm, for the selection of the parent processor core data MDAT which are transmitted and received to and from the parent processor 4, and a data selection circuit DSc, for the selection of the coprocessor core data CDAT which are transmitted are received to and from the coprocessor core 6.

The address selection circuits AS0 to ASn select either the parent processor address ADD or the coprocessor address CAD in response to the buffer designation data MBN(0)˜MBN(n), respectively, corresponding to the parent processor 4 set in the control register 9a so as to transmit the address to the corresponding buffer.

That is to say, the address selection circuits corresponding to the buffer designated by the parent processor 4 as the access objective select the parent processor address MAD so as to transmit the address to the corresponding buffer. On the other hand, the other address selection circuits, that is to say, the address selection circuits wherein the value of the corresponding buffer designation data MBN is “0” select the coprocessor address CAD so as to transmit the address to the corresponding buffer.

At the time of data read out, when data read out requested from the parent processor 4 or from the coprocessor core 6 and the control signal RDm or RDc is set at “1,” each of the read out control signals RD0 to RDn which, respectively, correspond to the buffers B0 to Bn is activated (set at “1”). In response to this, each of the buffers B0 to Bn carries out data read out in response to the address transmitted from the corresponding address selection circuit.

The data selection circuit DSm selects one piece of read out data, in accordance with the buffer designation data MBN from the read out data received from each buffer as the parent processor core data MDAT, so as to transmit said data to the parent processor 4. The data selection circuit DSc selects one piece of read out data in response to the buffer designation data CBN from the read out data received from each buffer as the parent processor core data MDAT so as to transmit said data to the coprocessor core 6.

At the time of data write in, the write in control signals WD0 to WDn, which correspond, respectively, to the buffers B0 to BN, are generated in accordance with the result of the logic operation between the corresponding buffer designation data MBN and the control signal WDm as well as between the corresponding buffer designation data CBN and the control signal WDc.

More concretely, in each buffer, in the case that this buffer is designated as the access objective by the parent processor 4 and the data write in indication is received from the parent processor, or in the case that this buffer is designated as the access objective by the coprocessor core 6 and the data write in indication is received from the coprocessor core 6, the corresponding data write in control signal is activated (set at “1”).

The address selection by the address selection circuits AS0 to ASn at the time of data write in is carried out in accordance with the buffer designation data MBN in the same manner as at the time of data read out, of which the detailed descriptions are not repeated.

The data MDAT from the parent processor 4 are transmitted to, and written into, the buffer designated as the access objective of the parent processor 4 by means of the selection circuit DSm, which carries out buffer selection in accordance with the buffer designation data MBN. In the same manner, the data CDAT from the coprocessor core 6 are transmitted to, and written into, the buffer designated as the access objective of the coprocessor core 6 by means of the data selection circuit DSc, which carries out buffer selection in accordance with the buffer designation data CBN.

In such a configuration, data can be shared between the parent processor and the coprocessor by using three, or more, buffers and, therefore, it becomes possible to further enhance the versatility of the processing operation.

In addition, it is also possible to achieve memory sharing wherein the versatility is further enhanced by introducing a configuration wherein the data of the control register 9b, at least, can also be written by the coprocessor core 6.

Even in such a configuration, the occurrence of data destruction and access conflict can be avoided by controlling the control registers 9a and 9b so as to have different values or, in the case that they have the same value, by adopting a control wherein access by the parent processor 4 is prioritized, for example, a method wherein the control register 9a for the parent processor designates the buffer which becomes the access objective of the parent processor 4 in a prioritized manner.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An arithmetic unit comprising:
a first arithmetic processing part for carrying out arithmetic processing; and
a memory part shared by said first arithmetic processing part and a second arithmetic processing part which allows arithmetic processing to be carried out independently of said first arithmetic processing part,
said memory part includes
first and second buffer parts allowing implementation of data write in and data read out independently of each other and
an access control part for determining pairs of each of said first and second buffer parts and one of said first or second arithmetic processing parts based on a buffer designation that can be changed by said second arithmetic part, and for carrying out exclusive access in each of said pairs.

2. The arithmetic unit according to claim 1, wherein
said first arithmetic processing part corresponds to a coprocessor while said second arithmetic processing part corresponds to a microprocessor unit.

3. The arithmetic unit according to claim 1, further comprising a control register allocated to a specific address, wherein said control register sets data for carrying out said buffer designation.

4. The arithmetic unit according to claim 1, wherein
said first and second buffers are allocated to a first address region in common;
said access control part has:
first and second address selection parts provided corresponding to said first and second buffer parts, respectively, and
first and second data selection parts provided corresponding, to said first and second arithmetic processing parts, respectively, wherein
said first and second address selection parts transmit first and second addresses, which are, respectively, addresses to which access is requested from said first and second arithmetic processing parts, to said first and second buffers, separately, in accordance with said buffer designation, and
said first and second data selection parts carry out data transmission and reception, respectively, in said combinations in accordance with said buffer designation.

5. The arithmetic unit according to claim 4, wherein said first and second buffers are further allocated to second and third address regions, respectively, which are different from said first address region and which are independent of each other.

6. The arithmetic unit according to claim 1, wherein
said buffer designation includes a read buffer designation for setting an access objective at the time of data read out and a write buffer designation for setting an access objective at the time of data write in, and
said access control part determines said pairs based on said read buffer designation and said write buffer designation, respectively, at said time of data read out and at said time of data write in, respectively.

7. The arithmetic unit according to claim 1, wherein
said buffer designation includes a first sub-buffer designation which can be changed by both of said first and second arithmetic processing parts and a second sub-buffer designation which can be changed by said second arithmetic processing part, and
said access control part determines said pairs based on said first sub-buffer designation in the case that an access request is received from said first arithmetic processing part and determines said pairs based on said second sub-buffer designation in the case that an access request is received from said second arithmetic processing part.

8. The arithmetic unit according to claim 7, wherein
said access control part has:
first and second address selection parts provided corresponding to said first and second buffer parts, respectively; and
first and second data selection parts provided corresponding to said first and second arithmetic processing parts, respectively,
said first and second address selection parts transmit first and second addresses which are, respectively, addresses to which access is requested from said first and second arithmetic processing parts, to said first and second buffers, separately, in accordance with said second sub-buffer designation,
said first data selection part carries out data transmission and reception between one said first and second buffer parts, in accordance with said first sub-buffer designation, and said first arithmetic processing part, and
said second data selection part carries out data transmission and reception between one said first and second buffer parts, in accordance with said second sub-buffer designation, and said second arithmetic processing part.

9. The arithmetic unit according to claim 1, wherein said buffer designation is prohibited from being changed by said first arithmetic processing part.

10. The arithmetic unit according to claim 1, wherein a change of said buffer designation is possible by means of said first arithmetic processing part.

11. An arithmetic unit comprising:
a first arithmetic processing part for carrying out arithmetic processing; and
a memory part shared by said first arithmetic processing part and a second arithmetic processing part which allows arithmetic processing to be carried out independently of said first arithmetic processing part,
said memory part including
first and second buffer parts, which allow data write in and data read out independent of each other and each of which having two input/output ports, and
an access control part which transmits read out data from one of said first and second buffer parts, which is designated in accordance with a first read buffer designation that can be changed by said second arithmetic processing part, to said first arithmetic processing part and which transmits read out data from one of said first and second buffer parts, which is designated in accordance with a second read buffer designation that can be changed by said second arithmetic processing part, to said second arithmetic processing part, in the case that a data read out request is received from, at least, one of said first and second arithmetic processing parts,
said access control part transmitting write in data from one of said first and second arithmetic processing parts to one of said first and second buffer parts which is determined based on a write buffer designation that can be changed by said second arithmetic processing part in the case that a data write in request is received from the above specified first or second arithmetic processing part.

12. The arithmetic unit according to claim 11, further comprising a control register allocated to a specific address, wherein said control register sets a data group for carrying out said first and second read buffer designations and said write buffer designation.

13. The arithmetic unit according to claim 11, wherein said first and second read buffer designations and said write buffer designation are prohibited from being changed by said first arithmetic processing part.

14. The arithmetic unit according to claim 11, wherein a change of said first and second read buffer designations and said write buffer designation is allowed by means of said first arithmetic processing part.

15. An arithmetic unit comprising:
a first arithmetic processing part for carrying out arithmetic processing; and
a memory part shared by said first arithmetic processing part and a second arithmetic processing part which allows arithmetic processing to be carried out independently said first arithmetic processing part, wherein said memory part includes
a plurality of buffer parts, allowing implementation of data write in and data read out to be carried out independent of each other, and
an access control part which carries out access between one of said plurality of buffers which is determined based on a first buffer designation that can be changed by said second arithmetic processing part and said first arithmetic processing part as well as access between one of said plurality of buffers which is determined based on a second buffer designation that can be changed by said second arithmetic processing part and said second arithmetic processing part.

16. The arithmetic unit according to claim 15, further comprising first and second control registers allocated to, respectively, specific addresses, wherein said first and second control registers set, respectively, first and second pieces of data for carrying out said first and second buffer designations, respectively.

17. The arithmetic unit according to claim 15, wherein a change of said first and second buffer designations is prohibited by means of said first arithmetic processing part.

18. The arithmetic unit according to claim 15, wherein said first buffer designation can be changed by said first arithmetic processing part.

19. The arithmetic unit according to claim 15, wherein
said access control part has:
a plurality of address selection parts provided corresponding to said plurality of buffer parts, respectively; and
first and second data selection parts provided corresponding to said first and second arithmetic processing parts, respectively, wherein
each of said plurality of address selection parts transmits, in accordance with said second buffer designation, either first or second address, which is an address wherein access has been requested from said first or second arithmetic processing part, to corresponding one of said plurality of buffer parts,
said first data selection part carries out data transmission and reception between one of said plurality of buffer parts which is in accordance with said first buffer designation and said first arithmetic processing part, and
said second data selection part carries out data transmission and reception between one of said plurality of buffer parts which is in accordance with said second buffer designation and said second arithmetic processing part.

20. The arithmetic unit according to claim 15, wherein said first arithmetic processing part corresponds to a coprocessor while said second arithmetic processing part corresponds to a microprocessor unit.
